(19) United States
(12) Patent Application Publication
(10) Pub. No.: US 2002/0072473 A1
(43) Pub. Date: Jun. 13, 2002

(54) Cleaning aid

(75) Inventors: Alexander Thomas Ashcroft, Merseyside (GB); Melvin Carvell, Merseyside (GB); Clare Thomas Evans, Merseyside (GB); Peter Graham, Merseyside (GB); Matthew James Leach, Merseyside (GB); Colina Mackay, Merseyside (GB); Antonius Maria Neplenbroek, Maarssen (NL); Steven Rannard, Merseyside (GB); Bouke Suk, Maarssen (NL); David William Thornthwaite, Merseyside (GB)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 09/940,730

(22) Filed: Aug. 28, 2001

(30) Foreign Application Priority Data
Aug. 29, 2000 (GB) 0021182.1

(51) Int. Cl. A01N 3/02

(52) U.S. Cl. 504/113

(57) ABSTRACT

The invention concerns a method of removing soil from a surface, comprises the steps of:

(a) treating the surface with an antioxidant;

(b) allowing the soil to deposit; and

(c) cleaning the surface to remove the soil.

The invention also concerns the use of antioxidants on surfaces to facilitate removal of soil deposited on the surface treated with the antioxidant.

### FIELD OF THE INVENTION

The present invention relates to products to assist or effect the cleaning of a variety of surfaces, particularly hard surfaces such as stainless steel, formica, perspex, ceramic or enamel.

1. Background to the Invention

Household surfaces are normally cleaned using compositions which contain one or more ingredients which assist removal of fatty/oily/greasy soil and/or any visible staining such as from associated solid debris. Such compositions may be applied by pouring or as a spray, such as from a trigger spray dispenser or other aerosol applicator and rubbed with a cloth or other wipe, optionally followed by rinsing. However, it would be advantageous if the surface to be cleaned could be treated with a material, which would assist removal of soil and/or staining during subsequent cleaning.

We have now found that this function may be provided by an antioxidant.

JP-A-07/228,892 discloses hard surface cleansing compositions comprising anionic and amphoteric surfactants, a mono- or polyhydric alcohol and from 0.1% to 7% by weight of a tea leaf extract. In this application and in the references cited therein tealeaf extract in detergent compositions is said to prevent such compositions from causing chapping of the skin. Tea tannins are also said to give a deodorising effect. Whilst tannins are commonly known to be an ingredient of tea, actually, tannic acid (an antioxidant) is present only in very small quantities. Moreover, the role of tannins in assisting subsequent soil removal is not disclosed or suggested in this reference, on the contrary: tannins are said to generally adversely affect cleaning, especially of oily soil.

Other disclosures of using extracts of tea or other leaves in hard surface cleaning and/or disinfecting products are in JP-A-07/228,890 and '891, JP-A-08/104,893, JP-A-10/273,698, JP-A-11/100,596, JP-A-06/340,897, JP-A-62/167,400, JP-A-59/-047,300 and U.S. Pat. No. 4,220,676, although the products disclosed in the latter two contain no surfactant.

A hard surface cleaner containing from 1% to 70% by weight of anionic surfactants, 0.5% to 20% nonionic surfactants and from 0.001% to 5% by weight of tannins is disclosed in JP-A-63/196,693. An example composition comprises 15% alkylbenzene sulphonate anionic surfactant, 5% polyoxy-ethylene sulphate anionic surfactant, 5% coco fatty acid cliethanolamide nonionic surfactant and 1% tannic acid.

U.S. Pat. No. 4,094,701 discloses aqueous alkaline solutions of pH at least 9 containing a tannin and optionally, surfactant, for cleaning and etching a tin surface in the tin plate/can industry. The amounts of tannin mentioned rage from 0.01 to 0.05 wt% of the composition. The amount. of surfactant in any such composition never exceeds 0.16 wt%.

U.S. Pat. No. 5,965,514 discloses mildly acidic hard surface cleaning compositions containing amine oxide surfactant, quaternary disinfectant and a nitrogen-containing chelating agent. Optionally, a surface tension reducing agent may be included. In aqueous form, they are said to have good residue/filming properties. Ascorbic acid is mentioned among a large number of possible acids to provide acidity, but not among the preferred ones. Tannic acid is mentioned as one of a large number of alternative possible acids useful as surface tension reducing agents. It is stated that preferred members of this list can be used in amounts of from 0.005 to 2 wt%. However, again, tannic acid is not mentioned in this preferred list nor otherwise referred to.

Compositions for stabilising liquid or solid soap compositions for personal washing are disclosed in EP-A-0 955 355. These compositions comprise either one type or one or two different types of antioxidant, one of these being phenolic type defined by a general formula, and a surfactant. The amount of antioxidant in the compositions is given as from 0.001 to 0.1 wt% of the composition, but in the case of a liquid soap, the upper limit is given as 0.05 wt%.

An antifogging agent for glass is described in JP-A-49/113,811. This comprises by weight, 3% dialkyl sulfosuccinate anionic surfactant, 4% higher secondary alkoxyethyl sulfate anionic surfactant, 1% tannic acid, 10% propylene glycol, 5% isopropyl alcohol and 77% water.

CA-A-2 144 021 discloses microbiocidal compositions comprising short and intermediate chain fatty acids, a non-toxic phenolic compound and a solubiliser. The exemplified non-toxic phenolic compounds are compounds, which are antioxidants. They are added to promote the anti-microbial properties of the composition. However, their use to promote cleaning is not disclosed at all. The amount of phenolic compound before dilution of the product is from 1% to 5%, by weight.

In EP-A-0 200 264, EP-A-0 487 169 and EP-A-0 509608 antioxidants are mentioned among the many optional components in detergent compositions without any indication as to the purpose for adding them.

U.S. Pat. No. 5,895,781 discloses a cleaning composition for removing high oxidation state metal co-ordination complex stains which contain an acid, a reducing agent and a surfactant system. The reducing agent may be isoascorbic acid.

JP-A-03/190999 discloses cleaner compositions for ceramic and metal surfaces comprising an organic acid such as ascorbic acid and an inorganic powder as a scouring agent.

EP-A-0 512 328, U.S. Pat. No. 5,330,673 and U.S. Pat. No. 5,602,090 disclose cleaning compositions containing easily oxidisable terpenes such as cold pressed lemon oil and limonene. The example formulations contain minor amounts of an antioxidant such as butylated hydroxyanisole.

EP-A-1 069 178 discloses fabric treatment compositions comprising a surfactant, a chelating agent, a peroxide bleach and a so called radical scavenger such as propyl gallate or butyl-hydroxy anisole.

In EP-A-0 411 708 acidic hard surface cleaners are described comprising one or more of a large group of organic acids for safe removal of soap scum and lime scale from bathtubs, sinks and tiles and the like. Ascorbic acid is mentioned as one of a large number of suitable organic acids.

In U.S. Pat. No. 6,046,148 acid light duty cleaning compositions are described wherein the acidity is given by an organic acid. Again ascorbic acid is mentioned as one of the many possibilities.

However, it is nowhere disclosed in the prior art that the treatment of a surface with an antioxidant would have any positive effect on the subsequent removal of oily soil thereafter deposited on that surface.

2. Definition of the Invention

Thus, a first aspect of the present invention provides a method of removing soil from a surface, the method comprising the steps of:

(a) treating the surface with an antioxidant;

(b) allowing the soil to deposit; and

(c) cleaning the surface to remove the oil.

A second aspect of the present invention provides use of an antioxidant for application to a surface to be cleaned subsequently to enable easier removal of soil from the surface during said subsequent cleaning. As a third aspect the invention also provides the use of an antioxidant in the manufacture of compositions for use according to previous aspects of the invention.

### DETAILED DESCRIPTION OF THE INVENTION

Whilst not being bound by any particular theory or explanation, we believe that the antioxidant exerts its effect by being retained on the surface in step (a), so that soil subsequently deposited on the surface in step (b) does not toughen or polymerize, thereby allowing easier removal of the soil in step (c). Therefore, one embodiment of the first aspect of the invention comprises formation of a film comprising the antioxidant in step (a), e.g. by leaving a solution or liquid composition comprising the antioxidant to dry on the surface. This solution or liquid composition does not itself need to have cleaning properties, since actual cleaning is only performed in step (c) after which preferably step (a) is repeated to apply a new film of antioxidant. However, in a preferred embodiment step (c) is advantageously effected using a hard surface cleaning composition again comprising the antioxidant so that soil is removed and new antioxidant is applied at the same time, thus effectively combining step (c) of the first process according to the first aspect of the invention with step (a) of a subsequent process according to this aspect of the invention. Step (c) is optionally followed by a rinsing step, usually with water.

As used herein, the term “soil” encompasses all kinds of staining or soiling of organic or inorganic origin, whether visible or invisible to the naked eye, including soiling of solid debris and/or with bacteria or other pathogens. The invention is particularly effective for easier removal of fatty soil, more specifically aged or baked-on fatty soil. Usually such fatty soil, as often found e.g. on kitchen surfaces, comprises an oil/fat component in combination with other soil components such as food remains of starchy and/or proteinaceous nature, dust, lime scale deposits, etc.

Thus, in a specific aspect the invention provides a method for removing fatty soil from a surface, the method comprising the steps of:

(a) treating the surface with an antioxidant;

(b) allowing the fatty soil to deposit; and

(c) cleaning the surface to remove the soil.

The present invention may also deliver one or more other benefits such as improved tactile properties of the surface (e.g. smoothness) during and/or after cleaning, reduction of rancid smell and less darkening of the soil before cleaning, less surface corrosion and less noise during cleaning. Further aspects of the present invention comprise use of an antioxidant or composition containing an oxidant, for delivery of one or more of these other benefits in a hard surface cleaning operation and/or use of the antioxidant in the manufacture of products for delivering one or more such other benefits.

Methods, uses as well as compositions and other products according to the present invention are useful for treating any household surfaces, particularly hard surfaces in for example kitchens and bathrooms including cooker tops, extractor fans, work surfaces, cooking utensils, crockery, tiles, floors, baths, toilets, wash basins, showers, dishwashers, taps, sinks, and glass and enamel surfaces in general. These surfaces may, for example, consist of paint (e.g. painted or lacquered wood), plastics, glass, ceramic or metal (e.g. stainless steel or chrome).

The Antioxidant

As disclosed in Ingold K.V. Adv.Chem.Ser.75, 296-305 (1968) “Inhibition of Autooxidation”, antioxidants fall into two groups, namely primary (or chain-breaking) antioxidants which react with lipid radicals to form more stable radicals, and secondary (or preventative) antioxidantis which reduce the rate of chain initiation by various mechanisms. Further antioxidants may be classified as synthetic or “natural”, i.e. derived from natural products.

The following are classes, sub-classes and specific examples of antioxidants, which may be used in methods, uses, articles and compositions according to the present invention. As used herein, the term “antioxidant” in the singular embraces one antioxidant as well as two or more antioxidant materials in combination.

A. Synthetic Antioxidants

In general, primary antioxidants are subdivided into chain-breaking acceptors and chain-breaking donors.

Chain-breaking acceptors (sometimes called “preventative antioxidants”) reduce oxidation rates by decomposing hydroperoxides into (non-radical) stable end products. Examples of synthetic chain-breaking acceptors include lauryl thiodipropionate, thiodipropionic acid and metal dithiocarbamates.

Chain-breaking donors (sometimes called “hydrogen-donating antioxidants or radical scavengers) function by competing with organic materials for peroxy radicals. Examples of synthetic chain-breaking donors are known in the art. Examples of natural chain-breaking donors include tocopherols, ubiquinol in lipids, uric acid and ascorbic acid in serum.

Secondary antioxidants are subdivided into inter alia peroxide decomposers, metal deactivators and (singlet oxygen) quenchers.

Thermally induced homolytic decomposition of peroxides and hydroperoxides to free radicals increases the rate of oxidation. Peroxide decomposers function by decomposition to non-radical species and removes the hydroperoxides as potential oxidation initiators. Most peroxide decomposers are derived from trivalent phosphorus compounds, such as phosphites and phosphonites, and divalent sulfur derivatives.

Esters of phosphorous acid derived from aliphatic alcohols and unhindered phenols (e.g. tris(nonylphenyl)phosphate) and hindered phenols (e.g. tris(2,4-ditert-butylphenyl)-phosphite, tetrakis(2,4-di-tert-butylphenyl)-4,4′-biphenylene-diphosphonite and bis(2,4-ditert-butylphenyl)-pentaerythritol)diphosphate) can be used.

Thiosynergists are another group of synthetic peroxide decomposers. They are sulfur containing compounds, which are used in conjunction with other (primary) stabilizers to enhance the effectiveness of the primary stabilizers. One commercial thiosynergist is dilaurylthiodipropionate.

Metal deactivator compounds, such as hindered phenolic diamides and hindered phenolic ester amides, complex with metal ions to change their redox properties. Metals having suitable oxidation-reduction potentials (e.g. Co, Cu, Fe, Mn, etc.) reduce the length of the autoxidation induction period and increase the oxidation rate. Sequestrants are compounds, which can bind and inactivate metal ions.

Oxamides are synthetic metal deactivator compounds which have long been known. More recently, other chemical classes, notably hydrazides, have become available commercially (optionally used in conjunction with hindered phenolics). Irganox MD 1024 and Naugard XL1 are effective as sole stabilizers as they already contain hindered phenol functionality.

B. Natural Antioxidants

Natural antioxidant compounds are particularly preferred. Natural components have a particular appeal to many consumers. Particularly preferred are those antioxidants which are considered to be safe for use on surfaces which may come into contact with food preparations.

Any such compound may exhibit one or more of the mechanisms of anti-oxidation of the classes and sub-classes as hereinbefore described for the synthetic antioxidants. However, probably most or all of them are free-radical scavengers, i.e. primary antioxidants. Diverse sources of natural materials exhibiting antioxidant activity have been reported including herbs, spices, cereals, coffee and beans, oils and seeds, tea leaves and protein hydrolysates. The active compounds, isolated from the extracts, responsible for exhibiting antioxidant activity include compounds from the chemical classes: tocopherols, flavanoids, phospholipids, organic acids and their derivatives, tannins, melanoidins, terpenes, sterols, Maillard reaction products and amino acids. Depending on the structure the antioxidants may be water-soluble or oil-soluble; both types are useful for the present invention.

Carnosol, carnosic acid, rosmanol, rosmarinic acid, rosmariquinone and rosmaridiphenol are known as active components of rosemary leaves which exhibit antioxidant activity. Furthermore, two major phenolic antioxidant components, gallic acid and eugenol are derived from cloves. Of the large number of compounds isolated from the extracts of herbs and spices such as sage, marjoram, oregano and thyme, some are known to have potent antioxidant properties. Other natural antioxidants include β-carotene, caffeic, quinic and ferulic acid, and esters of caffeic acid with sterols (sitosterol, campesterol, gramisterol and cycloartenol). The sterol and triterpene alcohol esters of caffeic acid are not suitable. Further such compounds known to exhibit potent antioxidant activity include cinnamic, sinapic, vanillic, syringic and coumaric acids.

Cardanol is a mixture of monohydroxyl phenols with a meta (3-) 15-carbon chain on the phenyl ring. It is isolated as a distillate from cashew nut shell liquid. Anacardic acid (3-n-pentadecylsalicylic acid) is the main component (80-85%) while cardanol (3-n-pentadecyl-phenol) and cardol (3-n-pentadecyl-resorcinol) and methyl cardanol (2-methyl-5-n-pentadecyl-resorcinol) are present in smaller amounts. Cardol and cardanol are commercially available. Oryzanol refers to a group of esterified sterols, which have been reacted with ferulic acid (4-hydroxy-3-methoxycinnamic acid)having high molecular weight and low volatility. Sesamol, sesaminol and sesamolino compounds are constituents of sesame oil and have antioxidant properties. Sesamol readily undergoes oxidation to sesamol dimer and further oxidation yields the sesamol quinone dimer.

Tocopherols provide strong antioxidant activity. Like most or natural antioxidants, tocopherols function by scavenging free radicals by their phenolic group, thus slowing down the propagation step in the autoxidation radical sequence. Under certain conditions tocopherols can form higher molecular weight materials in oils e.g. dimers, trimers, etc. Tocotrienols are a related class of compounds with the structural difference being an unsaturated side chain instead of a saturated phytyl chain. The antioxidant activity of tocotrienols is less than that exhibited by tocopherols. Both tocopherols and tocotrienols are known to function synergistically with ascorbic, citric, tartaric and amino acids.

Some polyphenolic flavanoid compounds function as primary antioxidants, chelators and superoxide anion scavengers. These compounds function by both the “chain-breaking” and “metal deactivating” mechanisms. The class of flavanoids is divided into subgroups of which the major members include flavanols, flavones, isoflavones, anthocyanins, catechins, proanthocyanidins and aurones. Related compounds include cinnamic and ferulic acids and their esters, some of which are precursors to flavanoids. Tea leaves are a rich, inexpensive and readily available source of flavanoids (mainly catechins). When oxidised the flavanoids form polyners with complex polyphenolic structures, themselves showing antioxidant activity.

Superior to BHA and α-tocopherol as antioxidants in retarding lipid oxidation, is epigallocatechin garlate which can be extracted from tea in synergism with ascorbic acid, tocopherol, citric and tartaric acids. The antioxidant activity of flavanols is related mainly to the hydroxy-group in the 3-position, the ketone at the 4-position in the pyrone ring and the double bond present at the 2,3-position. The hydroxy groups present at the 3′, 4′and 5, 7 or 8- positions also contribute to the antioxidant properties.

Rutin and chlorogenic acid also exhibit antioxidant properties, having sugar moieties attached to aromatic functionality.

Compounds of this type are particularly interesting since they can partition between aqueous and organic (lipid) phases.

Another group of natural antioxidants is the tannins, tannic acid and related compounds. It is a broad group of plant derived polyphenolic compounds. The tannins are characterised by their ability to precipitate proteins.

Antioxidant structure

Preferred antioxidants for the purpose of this invention are those which contain one of the following substructures:

HO>=<OH

HO>=−=<OH

or a derivative thereof in which of one or both OH (preferably only one) the H has been replaced by an organic group. The organic group may be —R or —COR wherein R is preferably a (substituted) alkyl, alkenyl, carbocycl:ic or heterocyclic group Preferably these substructures are part of a carbocyclic ring. Many of the natural and synthetic antioxidants referred to above fall in this category. Well known examples are ascorbic acid and its stereoisomers and the salts and ascorbyl derivatives thereof, such as ascorbyl palmitate and other ascorbyl esters. For the purposes of this invention the term “ascorbic acid” also comprises its stereoisomers.

If the carbocyclic ring is a benzene ring the substructures denote 1,2- and 1,4-dihydroxybenzene units respectively, or derivatives thereof. Suitable examples of compounds having the 1,2-dihydroxybenzene(derivative) substructure are caffeic, ferulic, rosmarinic, and vanillic acid and their amides, esters, salts and similar derivatives, as well as sesamol and its derivatives. Suitable examples of compounds having the 1,4-dihydroxybenzene derivative substructure are the tocopherols and tocotrienols wherein part of the benzene ring and one of the phenolic oxygens together form part of a heterocyclic ring.

A specific and very useful subclass of compounds having the 1,2-dihydroxybenzene substructure is formed by those having the 3,4,5-trihydroxybenzoyl structure or substituted derivatives thereof. Thus, gallic acid and its amides, esters and salts are particularly preferred, as are tannic acid and tannins. Tannic acid and tannins contain a plurality of 3,4,5-trihydroxybenzoyl units whereby the benzoyl group of one unit forms an ester bond with a phenolic oxygen of the next unit.

Tannic acid is a preferred antioxidant for the purposes of this invention. It is sometimes denoted as gallotannic acid or penta- (m-digalloyl) -glucose (C₇₆H₅₂O₄₆). However, commercially available tannic acid is usually obtained from plant and nut galls, tree barks and other plant parts and such materials are known to be gallic acid derivatives. The term “tannic acid” as used herein is to be taken to embrace all such materials. As already mentioned, tannin-containing extracts of tea (e.g. as utilised in the compositions of JP-A-07/228,892) are very low in tannic acid content.

A further aspect of the present invention provides a cleaning composition comprising surfactant, more than 0,05%, preferably from 0.1% to 10% by weight of an antioxidant selected from:

a) tannic acid, its esters and salts;

b) gallic acid, its amides, esters and salts;

c) tocopherols and tocotrienol;

d) ascorbic acid, its salts and ascorbyl derivatives;

e) mixtures of a and b;

f) mixtures of a and c;

g) mixtures of a and d;

h) mixtures of b and c;

i) mixtures of b and d;

j) mixtures of c and d;

k) mixtures of a, b and c; a, b and d; a, c and d; b, c and d; and a, b, c and d;

optionally in combination with one or more other antioxidant materials, and water. Preferred types and amounts of surfactants and surfactant blends are recited elsewhere in this specification. The minimal amount of the antioxidant may be 0.01%, 0.05%, 0.1%, or 0.2% by weight, and the maximum may be 5%, 2.5%, 1.5% or 1% by weight.

Form of utilisation of the antioxidant

The antioxidant(s) may be applied to the surface neat or in diluted form. Preferably they are applied in liquid diluted form such as a solution, emulsion or dispersion, or by means of a wipe impregnated with the antioxidant(s) or impregnated with a solution, emulsion or dispersion containing the antioxidant(s). Suitable liquid formulations include solutions, dispersions or emulsions of the antioxidant material in a solvent. The solvent may be an organic solvent, e.g. ethanol or isopropanol, or water, or a mixture of organic solvent and water, but preferably water. The liquid formulations, also referred to herein as “compositions” may be used to only deposit antioxidant, or they may have additional functions on the surface, such as cleaning. Hard surface cleaning compositions are further described below.

Even if the compositions are only or primarily intended to deposit antioxidant on the surface, they may contain other components, such as emulsifier to help disperse the antioxidant in the liquid or on the surface. However, such compositions do generally not require a detergent surfac:tant and therefore the surfactant content can be below 0.1% by weight, or even below 0.05% by weight or even be 0. They may, however, contain a metal ion sequestrant as described below for hard surface cleaning compositions.

The compositions must be suitable for depositing the antioxidant material onto the surface. The antioxidant(s) may be present in the composition in any suitable form, for example as a solution or a dispersion. Except where expressed or implied to the contrary, the compositions may also be in solid form, to be wetted upon use. However, in preferred embodiments, and in some aspects of the invention as a whole, they are liquids, more preferably aqueous liquids. The term “liquid” includes solutions, dispersions, emulsions, gels, pastes and the like. Although there are no general pH limitations for such liquids it is preferred to keep pH below 12. Also, some antioxidants, such as tannic acid, tend to form dark coloured condensation products when kept at high pH. For such antioxidants the pH is preferably kept sufficiently low to prevent this phenomenon from occurring, e.g. below 8, more preferably at or below 7, 6 or even 5.5

In general, the total antioxidant component of any such composition, may for example be from 0.01% to 10% preferably 0.05% to 5% by weight of that composition. In many cases an amount of at most 1% will suffice to obtain the desired effect.

The composition may be applied by any suitable means. For example, it can be poured or sprayed onto the surface from a container or from an aerosol can or from a trigger spray applicator.

Cleaning compositions

Cleaning compositions for use in the present invention, apart from having any suitable combination of properties described above, may include any normal cleaning ingredient

Preferably, a cleaning composition comprises at least one detergent surfactant and optional other cleaning components.

It is preferred if the cleaning composition is a liquid and such liquids are particularly (though not exclusively) useful for cleaning hard surfaces. This liquid composition may be in the form of a thin or viscous liquid or gel or in the form of foam, mousse of paste. It is especially preferred if the liquid is viscous or gel-like having a viscosity of at least 100 centipoise (mPas), preferably at least 150 or even 200 mPas, as measured at a shear rate of 21s⁻¹ (Brookefield viscometer, 20° C.), but preferably no more than 5,000 centipoise, more preferably at most 2000. Shear thinning viscous liquids or gels enhance the pleasing sensory effect of the antioxidant during cleaning of a hard surface and are particularly appealing to the consumer and therefore a preferred embodiment of the invention. The viscosity may be brought about by an “internal structuring system” employing one or more surfactants, water, and (usually) electrolyte, to create an ordered or liquid crystalline phase within the composition. Alternatively or additionally a thickening polymer may be added, many of which are known in the art, for example polycarboxylate type polymers such as poly(meth)acrylates, polymaleic acids and copolymers of (meth)acrylic acid and/or maleic anhydride with various other vinylic monomers, or polysaccharides such as cellulose derivatives or vegetable or microbial gums e.g. xanthan gum, guar gum and the like. Xanthan gum is particularly preferred for its ability to give aesthetically pleasing clear viscous liquids.

Foams and mousses are normally supplied from a dispenser who gassifies or aerates the product dispensed therefrom.

Thus, yet another aspect of the invention comprises a liquid composition having a pH less than 12 and comprising an antioxidant, said composition having a viscosity of at least 100 mPaS at a shear rate of 21s⁻¹, the total amount of antioxidant in the composition being at least 0.05% by weight of the composition.

Preferred compositions are either low foaming, or if foaming or applied as a foam, the foam easily collapses, thus obviating the need to subsequently rinse or wipe the surface again to remove foam. Thereby the amount of antioxidant remaining on the surface is maximised.

Surfactants:

A composition according to (or for use in) the invention can comprise detergent surfactants which are generally chosen from anionic, nonionic, amphoteric, zwitterionic or cationic surfactants. The compositions generally comprise at least 0.05%, preferably at least 0.1, 0.2, 0.5 or even 1% by weight, but not more than 45% usually at most 25, 15 or even 10% by weight of total surfactant. Preferably the compositions comprise at least an anionic and/or nonionic surfactant, more preferably at least a nonionic surfactant.

Suitable synthetic (non-soap) anionic surfactants are water-soluble salts of organic sulphuric acid esters and sulphonic acids which have in the molecular structure an alkyl group containing from 8 to 22 carbon atoms.

Examples of such anionic surfactants are water soluble salts of:

(primary) long chain (e.g. 8-22 C-atom) alcohol sulphates (hereinafter referred to as PAS), especially those obtained by sulphating the fatty alcohols produced by reducing the glycerides of tallow or coconut oil;

alkyl benzene sulphonates, such as those in which the alkyl group contains from 6 to 20 carbon atoms;

secondary alkanesulphonates;

Also suitable are salts of:

alkyl glyceryl ether sulphates, especially those ethers of the fatty alcohols derived from tallow arid coconut oil;

fatty acid monoglyceride sulphates;

sulphates of the reaction product of one mole of a fatty alcohol and from 1 to 6 moles of ethylene oxide;

salts of alkylphenol ethyleneoxy-ether sulphates with from 1 to 8 ethyleneoxy units per molecule and in which the alkyl groups contain from 4 to 14 carbon atoms;

the reaction product of fatty acids esterified with isethionic acid and neutralised with alkali;

and mixtures of the above.

The preferred water-soluble synthetic anionic surfactants are the alkali metal (such as sodium and potassium) and alkaline earth metal (such as calcium and magnesium) salts of alkyl-benzenesulphonates and mixtures with olefinsulphonates and alkyl sulphates, and the fatty acid mono-glyceride sulphates. The most preferred anionic surfactants are alkyl-aromatic sulphonates such as alkylbenzenesulphonates containing from 6 to 20 carbon atoms in the alkyl group in a straight or branched chain, particular examples of which are sodium salts of alkylbenzenesulphonates or of alkyl-toluene-, -xylene- or -phenolsulphonates, alkylnaphthalene-sulphonates, ammonium diamylnaphthalene-sulphonate, and sodium dinonyl-naphthalene- sulphonate.

If synthetic anionic surfactant is to be employed the amount present in the compositions of the invention, it will generally be at least 0.2%, preferably at least 0.5%, more preferably at least 1.0%, but not more than 20%, preferably at most 10%, more preferably at most 8%.

Although in the widest sense, soaps are not excluded from the present invention, compositions of (or for use in) the present invention are substantially free from soap, for example containing less than 5%, preferably less than 1%, more preferably less than 0.1% by weight of soap, especially totally free of soap.

Suitable nonionic surfactants can be broadly described as compounds produced by the condensation of alkylene oxide groups, which are hydrophilic in nature, with an organic hydrophobic compound which may be aliphatic or alkyl aromatic in nature. The length of the hydrophilic or polyoxyalkylene radical which is attached to any particular hydrophobic group can be readily adjusted to yield a water-soluble compound having the desired balance between hydrophilic and hydrophobic elements. This enables the choice of nonionic surfactants with the right HLB, taking into account the presence of the organic solvent and possible hydrocarbon co-solvent in the composition.

Particular examples include the condensation product of aliphatic alcohols having from 8 to 22 carbon atoms in either straight or branched chain configuration with ethylene oxide, such as a coconut oil ethylene oxide condensates having from 2 to 15 moles of ethylene oxide per mole of coconut alcohol; condensates of alkylphenols whose alkyl group contains from 6 to 12 carbon atoms with 5 to 25 moles of ethylene oxide per mole of alkylphenol; condensates of the reaction product of ethylenediamine and propylene oxide with ethylene oxide, the condensates containing from 40 to 80% of ethyleneoxy groups by weight and having a molecular weight of from 5,000 to 11,000.

Other examples are: alkylglycosides which are condensation products of long chain aliphatic alcohols and saccharides; tertiary amine oxides of structure RRRNO, where one R is an alkyl group of 8 to 18 carbon atoms and the other Rs are each alkyl or hydroxyalkyl groups of 1 to 3 carbon atoms, for instance dimethyldodecylamine oxide; tertiary phosphine oxides of structure RRRPO, where one R is an alkyl group of 8 to 18 carbon atoms and the other Rs are each alkyl or hydroxyalkyl groups of 1 to 3 carbon atoms, for instance dimethyl-dodecylphosphine oxide; and dialkyl sulphoxides of structure RRSC) where one R is an alkyl group of from 10 to 18 carbon atoms and the other is methyl or ethyl, for instance methyltetradecyl sulphoxide; fatty acid alkylolamides; alkylene oxide condensates of fatty acid alkylolamides and alkyl mercaptans. Ethoxylated aliphatic alcohols are particularly preferred.

The amount of nonionic surfactant to be employed in the cleaning composition of the invention will preferably be at least 0.1%, more preferably at least 0.2%, most preferably at least 0.5 or even 1% by weight. The maximum amount is suitably 15%, preferably 10% and most preferably 7%.

The compositions may contain amounts of both anionic and nonionic surfactants which are chosen, bearing in mind the level of electrolyte present, so as to provide a structured liquid detergent composition, i.e. one which is ‘self-thickened’. Thus, in spite of the presence of organic solvent, thickened liquid cleaning compositions can be made without the need to employ any additional thickening agent and which nevertheless have a long shelf life over a wide temperature range.

The weight ratio of anionic surfactant to nonionic surfactant may vary, taking the above considerations in mind, and will depend on their nature, but is preferably in the range of from 1:9 to 9:1, more preferably from 1:4 to 4:1, According to an embodiment illustrating any aspect of the invention, the compositions may comprise from 0.1.% to 7% by weight of antioxidant(s), from 0 to 20%, preferably from 0.2% to 10% by weight of a water-soluble, synthetic anionic sulphate or sulphonate surfactant salt containing an alkyl radical having from 8 to 22 carbon atoms in the molecule, and from 0.2 to 7% by weight of an ethoxylated nonionic surfactant derived from the condensation of an aliphatic alcohol having from 8 to 22 carbon atoms in the molecule with ethylene oxide, such that the condensate has from 2 to 15 moles of ethylene oxide per mole of aliphatic alcohol, the balance being other optional ingredients and water.

Suitable amphoteric surfactants that optionally can be employed are derivatives of aliphatic secondary and tertiary amines containing an alkyl group of 8 to 18 carbon atoms and an aliphatic group substituted by an anionic water-solubilising group, for instance sodium 3-dodecylamino-propionate, sodium 3-dodecylaminopropane sulphonate and sodium N-2-hydroxydodecyl-N-methyl taurate.

Suitable cationic surfactants that optionally can be employed are quaternary ammonium salts having one or two aliphatic groups of from 8 to 18 carbon atoms and two or three small aliphatic (e.g. methyl) groups, for instance cetyltrimethyl ammonium bromide.

Suitable zwitterionic surfactants that optionally can be employed are derivatives of aliphatic quaternary ammonium, sulphonium and phosphonium compounds having an aliphatic group of from 8 to 18 carbon atoms and an aliphatic group substituted by an anionic water-solubilising group, for instance 3-(N,N-dimethyl-N-hexadecylammonium) propane-1-sulphonate betaine, 3-(dodecyl methyl sulphonium) propane-1-sulphonate betaine and 3-(cetylmethyl phosphonium) ethane sulphonate betaine.

Further examples of suitable surfactants are compounds commonly used as surface-active agents given in the well-known textbooks “Surface Active Agents” Vol.1, by Schwartz & Perry, Interscience 1949, Vol.2 by Schwartz, Perry & Berch, Interscience 1958, in the current edition of “McCutcheon's Emulsifiers and Detergents” published by Manufacturing Confectioners Company or in “Tenside-Taschenbuch”, H. Stache, 2nd Edn., Carl Hauser Verlag, 1981.

The compositions according to the invention can contain other ingredients which aid in their cleaning performance. For example, the composition can contain detergent builders such as nitrilotriacetates, polycarboxylates, citrates, dicarboxylic acids, water-soluble phosphates (especially ortho-, pyro- or poly-phosphates or mixtures thereof), zec,lites and mixtures thereof in an amount of up to 25%. If present, the builder preferably will form at least 0.1% of the composition.

The compositions according to the present invention may include abrasives. However, these are generally not preferred as abrasives tend to damage or remove the antioxidant film being deposited on the surface. Some of the builders mentioned above can additionally function as abrasives if present in an amount in excess of their solubility in water.

Metal ion sequestrants such as ethylenediaminetetraacetates, polyphosphonates (DEQUEST™-range) and the (ortho, pyro, poly) phosphoric acids/phosphates (hereinafter collectively referred to as “phosphate”), and a wide variety of poly-functional organic acids (particularly citric acid) and salts, can also optionally be employed provided they are compatible with the antioxidant. Such sequestrants are particularly useful when combined with antioxidants which may form coloured complexes with metals, such as is the case for tannic acid, tannins and gallic acid and derivatives. The amount of such sequestrants, if present, is usefully between 0.05 and 5% by weight of the composition, preferably 0.1-1%. Thus, very useful for the purposes of the present invention are combinations of tannic acid and/or gallic acid or derivatives tereof with citric acid or phosphate in an amount of 0.1-1%, preferably 0.15-0.5% by weight. Specific examples include tannic acid + citric acid, gallic acid + citric acid, propyl gallate + citric acid, propyl gallate and phosphoric acid in a total amount of between 0.1 and 1% by weight and a ratio of between 1:5 and 5:1.

A further optional ingredient for compositions according to the invention is a suds regulating material, which can be employed in compositions which have a tendency to produce excessive suds in use.

One example of a suds regulating material is soap. Soaps are salts of fatty acids and include alkali metal soaps such as the sodium, potassium and ammonium salts of fatty acids containing from about 8 to about 24 carbon atoms, and preferably from about 10 to about 20 carbon atoms. Particularly useful are the sodium and potassium and mono-, di- and triethanolamine salts of the mixtures of fatty acids derived from coconut oil and ground nut oil. When employed, the amount of soap can form at least 0.005%, preferably 0.1% to 2% by weight of the composition. Fatty acid soaps such as Prifac 7901™ have been found to be suitable for this purpose.

A further example of a suds regulating material is a silicone oil. Where a hydrocarbon co-solvent is present at a sufficiently high level this may itself provide some or all of the desired antifoaming activity.

Compositions according to the invention can also contain, in addition to the ingredients already mentioned, various other optional ingredients such as colourants, whiteners, optical brighteners, soil suspending agents, detersive enzymes, gel-control agents, freeze-thaw stabilisers, bactericides, preservatives (for example 1,2-benzisoth:iazolin-3-one), and hydrotropes. Bleaching agents, such as hypohalites or hydrogen peroxide, may be present to the extent that they are compatible with the antioxidant. In general the compositions according to the invention will not contain bleaching agents. However, a composition containing a bleaching agent and a composition containing the antioxidant may be stored separately and mixed at the point of use to provide a mixed bleaching/antioxidant composition combining the advantages of both. Convenient so called “dual compartment” containers are known in the art for this purpose. Such containers comprise of two (or more) separate chambers or compartments in which liquids can bes stored separated from each other. They further comprise dispensing means for dispensing those liquids together whilst mixing them shortly before or during dispensing.

Liquid (as hereinbefore defined) hard surface treatment compositions according to the invention preferably have a pH less than 12, more preferably less than 10 or even 8. Preferred compositions have a neutral or slightly acidic pH i.e. at most 7, preferably at most 6, especially at most 5.5 or even 4.5 or less. However, it is preferred that the compositions should not be too acidic, in order to avoid damage to acid sensitive surfaces; preferably the pH is at least 2, more preferably at least 2.5. Most preferably, the pH is in the region from 3 to 4.5.

Useful optional components of the cleaning compositions according to the invention are organic solvent. Preferred are solvents with a solubility of at least 1% by weight in water. Suitable examples are the C1-C4 alkanols, the mono- and di-ethylene and mono- and di-propylene glycols and their monoalkyl ethers.

Liquid Dispensers

Liquid compositions may be stored and dispensed by any suitable means, but spray applicators are particularly preferred. Pump dispensers (whether spray or non-spray pumps) and pouring applicators (bottles etc) are also possible.

Thus, another aspect of the present invention provides a dispenser for a liquid product according to the invention, the dispenser comprising a reservoir containing an antioxidant in a liquid medium or a liquid composition having a pH less than 8 and comprising an antioxidant, and spray means for dispensing the liquid in the form of a spray.

The spray means is preferably a trigger spray but may be any mechanical means for ejecting the liquid in spray or aerosol form.

Wipes

Wipes can be impregnated with neat antioxidant(s) or with a solution/emulsion/dispersion containing the antioxidant(s). The material may be impregnated dry, or more preferably in wet form (i.e. as a thin or a viscous liquid). Suitable wipes include woven or nonwoven cloths, natural or synthetic sponges or spongy sheets, “squeegee” materials and the like.

Yet another aspect of the present invention provides a wipe impregnated with an antioxidant or a composition containing an antioxidant, such as any composition as defined or described elsewhere in this specification. Preferably the composition with which the wipe is impregnated also comprises a detergent surfactant. Optionally and preferably the composition “in ” the wipe also comprises an organic solvent such as the solvents described above.

Yet another aspect of the invention provides compositions for use in machine dish wash operation which comprise an antioxidant. The antioxidant are particularly suitable to be added to rinse aid compositions as are well known in the art of machine dish washing. Generally such compositions are aqueous liquids comprising an organic acid, such as citric acid, and/or a wetting surfactant, particularly nonionic wetting surfactant. The antioxidant may be added to the rinse aid composition in an amount of at least 0.05% and up to 20% by weight, more preferably up to 10%. Crockery, cutlery and cooking utensils which are soiled after having been treated with a rinse aid containing an antioxidant according to the invention are more easily and more completely cleaned in the next machined dish washing step. The antioxidants may also be used according to the invention in a rinse aid which is an integral part of a complete dish wash product in which the cleaning composition and the rinse aid are integrated.

The present invention will be elucidated further by way of reference to the following examples.

### EXAMPLES

In the following examples, all percentages are by weight unless stated to the contrary.

Example 1 - Kitchen Spray Composition

| | |
|---|---|
| Lial 111 10EO nonionic active | 2% |
| LAS acid anionic active | 3% |
| Tannic acid (Tanex ALSOK) | 0.5% |
| Magnesium sulphate 7H₂ · 0 | 0.9% |
| Radimix dicarboxylic acids | 0.4% |
| Proxel GXL preservative | 0.016% |
| Perfume | 0.35% |
| Sodium cumene sulphonate hydrotrope | 1% |
| Propylene glycol t-butyl ether solvent | 2% |
| Sodium hydroxide | to pH 4.5 |

Example 2 - Kitchen Spray Composition

As Example 1 but with the tannic acid replaced by 0.25% ascorbyl palmitate plus 0.25% alpha tocopherol.

Control 1

As Example 1 but without tannic acid.

Example 3 - Gel Composition

| | |
|---|---|
| 2% | Lial 111-5E0 Nonionic surfactant |
| 5% | Lial 111-10EO Nonionic surfactant |
| 0.5% | tannic acid (Tanex ALsok) |
| 0.1% | citric acid |
| 0.10% | Dequest 2010 sequestrant |
| 0.2% | Keltrol RD |
| 0.08% | Proxel (preservative) |
| balance water | |

pH adjusted to 4.5 with sodium hydroxide

Viscosity: 130cps (21s⁻¹) 32cps (106s⁻¹)

Control 2

As Example 3 but without tannic acid.

Example 4 - Impregnated Wipe

The following liquid composition was prepared.

2.88% isopropyl alcohol

2.16% butyl digol

0.134% benzalkonium chloride

0.36% nonionic surfactant C11 10 EO

0.5% tannic acid

0.144% perfume

0.05% sodium EDTA

balance water

The composition was buffered to pH 4.5 with NaOH/Citric acid.

Wipes in the form of non-woven 70% viscose/30% polyester cloths were stacked in a wipe dispensing box and impregnated by pouring-in the liquid composition.

Evaluation

Substrate Details

A stainless steel substrate was used for cleaning tests. This was brushed stainless steel size 380 mm by 300 mm (grade 304 sheet BS 1449 Pt2 1983, supplied by Merseyside Metal Services Ltd). This size tile accommodates two areas for cleaning, one on the left and one on the right of the tile. Each area for cleaning is 215 mm by 150 mm.

Pre-cleaning of Stainless Tiles

The tiles were pre-cleaned prior to a cleaning experiment as follows:

commercial liquid abrasive cleaner (Jif Cream cleaner), cleaning with a damp J-cloth and rinsed with hot water;

liquid dish-washing detergent (Persil Dishwashing Liquid), cleaning with a damp J-cloth and rinsed with hot water;

calcite, cleaning with a damp J-cloth and rinsed hot water, and finally rinsed with demineralised water;

after allowing the tiles to drain-dry, they are wiped with a paper towel, ensuring all calcite deposits are removed.

Application of Pre-treatment to Stainless Steel Tiles

A cardboard mount revealing the two areas of the tile to be pre-treated was placed onto the stainless steel tile. To one of the 215 mm x 150 mm areas, approximately half of a 1.0 ml pipetted aliquot of an example composition was applied in a line across the top 150 mm section of the pre-treatment area. The remaining portion of the 1.0 ml example composition was similarly applied to the lower 150 mm section of the area. The cardboard mount was carefully removed from the steel tile in readiness to wipe the applied prototype over the entire pre-treatment area. A dampened hand-wrung J-cloth™ (demineralised water) was folded around a 150 mm plastic ruler. This was used to spread the 1.0 ml aliquot of the composition being tested, over the steel surface. The prototype was spread using four linear wipes over the designated area, two downward and two upward wipes, and in each case 4 replicates for cleaning were prepared. After pre-treatment application, the tiles were allowed to dry for 2 hours before spraying with dehydrated castor oil soil.

Soiling and Ageing the Pre-treated Stainless Steel Tiles

The spraying of the castor oil soil was carried out in a fume cupboard under standard conditions to ensure good reproducibility between different experiments. The soil was dehydrated castor oil with 0.2% fat red 7B dye. This was stored in the refrigerator when not in use. It was equilibrated to ambient temperature before spraying.

The fume cupboard walls/floor and the lab-jack were covered with paper towel. A lab-jack was used to elevate the tile to a practical height for spraying. The lab-jack height was 200 mm and was positioned centrally at the back of the fume cupboard. A line 40 mm from the back wall of the fume cupboard was marked on to the top of the lab-jack, this was used as the positioning line for each steel tile before spraying. From the 40 mm line on the lab-jack, a line 270 mm, in parallel, was marked on the base of the fume cupboard floor. This was where the perspex spray guide was aligned when spraying.

A commercially available gravity fill spray gun was used to spray the oily soil onto the steel tile. The rear dial on the gravity fill gun was rotated 360° anti-clockwise from the closed position and the side dial was rotated 270° anti-clockwise, again from the closed position. The gravity fill spray gun was attached to a floor standing air compressor unit and a pressure of 25 p.s.i. was used for spraying this soil on to the steel tiles. A clamp stand was positioned in the fume cupboard to hold the spray gun when not in use. The dehydrated castor oil soil was poured into the open bowl of the spray gun.

The cardboard spray mount was clipped to a stainless steel tile and this was centrally placed, in landscape position, on the lab-jack along the 40 mm line from the rear of the fume cupboard. The cardboard spray mount was a rectangular piece of card, the same size as a stainless steel tile, with two cut-out areas sized 215 mm by 150 mm, one window area on the left side and the other to the right, with a card separator border between the two windows. The perspex spray guide was positioned in front of the first window of the tile to be sprayed directly on the 270 mm line. This area of the tile was sprayed for a total of 35 seconds starting from the top, following the line of the spray guide. The time taken to spray from top to bottom was approximately 9 seconds, therefore the track of the spray guide is traced 4 times, for each 215 mm by 150 mm area being sprayed. After spraying the first area of the tile, the adjacent area was sprayed in exactly the same way, after re-aligning the perspex spray guide in front of the second area. Once the entire tile had been sprayed twice, it was removed from the fume cupboard and the cardboard spray mount carefully removed. The sprayed tiles were stacked directly on to an oven shelf, each stainless steel tile being separated using an aluminium ring spacer placed in each corner.

These spacers enabled each tile to be separated by 10 mm. When all the tiles were sprayed, they were collectively placed in the oven for ageing.

The tiles were aged at a temperature of 85° C. for 1.5 hours. The prepared tiles were not cleaned until the next day.

The effort used to remove the soil from the test surface using a cellulosic spongecloth was measured on equipment specifically build for the purpose which measures the effort in Ns. The cleaning composition used to remove the soil was the composition of Control 2. Thus, the reduction in cleaning effort can only be attributed to the antioxidant in the pre-treatment composition

The results for the compositions of Example 1, Example 2 and the control 1 corresponding to Example 1 minus the tannic acid) are given in Table I. Those for the compositions of Example 3 and control 2 are given in Table II

Results given are geometric means of the 4 replicate experiments.

TABLE I

| | Average Log 10 | Average Total Effort |
|---|---|---|
| Treatment | Effort | (Ns) |
| No treatment (not | 3.798 | 6337 |
| totally clean in | | |
| 2 minutes) | | |
| Control 1 | 3.212 | 1639 |
| Example 1 | 1.998 | 109 |
| Example 2 | 2.868 | 791 |

TABLE II

| | Average Log 10 | Average Total |
|---|---|---|
| Treatment | Effort | Effort (Ns) |
| No treatment | 3.713 | 5171 |
| Control 2 | 3.177 | 1507 |
| Example 3 | 1.96 | 92 |

Results comparable to those of Example 3 were obtained with pre-treating the tiles with compositions according to Example 3 wherein the 0.5% tannic acid was replaced with:

0.5% ascorbic acid

0.5% δ-tocopherol

0.5% propyl gallate (pH 5.5, and pH 3.9)

0.5% tannic acid (pH 3,9)

0.25% gallic acid (pH 3.9)

0.5% caffeic acid

0.5% ferulic acid

0.5% 3,4-hydroxy-dihydrocinnamic acid

0.25% ascorbic acid +0.25% δ-tocopherol

0.25% ascorbic acid +0.25% (α-tocopherol

0.5% epigalocatechin gallate.

0.5% theaflavin digallate

0.1% tannic acid + 0.4% citric acid

0.25% tannic acid + 0.25% citric acid

0.25% gallic acid + 0.25% citric acid

0.25% propyl gallate + 0.25% citric acid

0.25% propyl gallate + 0.25% phosphoric acid

Example 5

In this example, the effect of applying tannic acid on ceramic dishes, in a rinse in a professional dishwash process was evaluated after several soiling/cleaning cycles.

The following test procedure was applied:

Ceramic dishes were first pre-rinsed with one of the rinse solutions described below and used further-on in the specific test concerned. Thereafter, these dishes were soiled entirely by spraying on a roux mixture. The roux mixture used for soiling the dishes was prepared by dissolving 1% wt potato starch (ex Honig) and 5% wt Roux Blanc (ex Nestle Foodservices) in 94% wt de-ionised water.

Thereafter the thus-obtained soiled dishes were dried for about 2-3 minutes at a temperature increasing from 25 to 75° C. Subsequently, the soiled dishes were cleaned (during 2 minutes) and rinsed (for about 10 seconds) in a multi-tank machine having a washing zone and a rinsing zone.

In the washing zone, a standard alkaline cleaning solution was applied, said solution containing de-ionised water and a cleaning agent dosed therein at a concentration of 1.5 g/l water. This cleaning agent contains 8%wt NTA, 37%wt KOH, 2%wt gluconic acid and 53% demi-water.

Three different experiments were executed. In all three experiments, a standard rinse aid (containing 10% of wetting nonionics and 10% of anti-foaming nonionics) was applied in the rinse zone at 0.5 g/l water.

Furthermore, an extra rinse was applied in experiment 2 and 3; this rinse product contained tannic acid and in experiment 3 also citric acid. This rinse product, which was sprayed together with the standard rinse aid onto the dishes, was also applied at 0.5 g/l rinse solution.

The compositions of these extra rinse products in the three experiments was as follows (amounts in %wt):

| Experiment: | I | II | III |
|---|---|---|---|
| tannic acid | — | 20 | 20 |
| citric acid | — | 0 | 10 |
| water | — | 80 | 70 |

After treating the ceramic dishes with the above cleaning and rinsing solutions, the dishes were soiled again.

The effect of tannic acid in combination with citric acid in the rinse solution on starch build-up oil the treated dishes was measured and evaluated after 2, 5 and 10 soiling/cleaning cycles. The level of starch remaining oil said dishes after these soiling/cleaning cycles was evaluated, using iodine to visualise the remaining starch.

The results in terms of the cleanliness after 2, 5 and 10 washing cycles are shown below.

| Effect obtained (% clean) | 2 cycles | 5 cycles | 10 cycles |
|---|---|---|---|
| Experiment I | 41 | 20 | 9 |
| (reference, no t.a.) | | | |
| Experiment II | 36 | 36 | 49 |
| (0.1 g/l t.a. in rinse) | | | |
| Experiment III | 76 | 75 | 86 |
| (0.1 g/l t.a. + | | | |
| 0.05 g/l c.a. in rinse) | | | |

Considering these results, it can be concluded that the significant starch build-up resulting from the use of standard dishwash cleaning agents can be prevented largely by using low levels of tannic acid in the rinse solution. This starch built up is prevented further when also citric acid is present in the rinse solution. This result indicates tITat citric acid promotes the anti-soiling effect of tannic acid.

1. A method of removing soil from a surface, the method comprising the steps, in sequence, of:
(a) treating the surface with an antioxidant;
(b) allowing the soil to deposit; and
(c) cleaning the surface to remove the soil.

2. A method according to claim 1 wherein the soil is a fatty soil.

3. A method according to claims 1 wherein the antioxidant is applied to the surface neat.

4. A method according to claims 1 wherein the antioxidant is applied to the surface in liquid diluted form.

5. A method according to claim 1 wherein the antioxidant is a natural antioxidant.

6. A method according to claims 1 wherein the antioxidant contains one of the following substructures:
HO>=<OH
HO>=−=<OH
or a derivative thereof in which of one or both oh (preferably only one) the H has been replaced by an organic group.

7. A method according to claim 6 wherein the antioxidant comprises ascorbic acid and salts thereof and ascorbyl esters.

8. A method according claim 6 wherein the substructure is a 1,2- or 1,4 dihydroxybenzene unit or derivative thereof.

9. A method according to claim 8 wherein the antioxidant is chosen from caffeic, ferulic rosmarinic and vanillic acid and their amides and esters and salts, sesamol and its derivatives, tocopherols and tocotrienols.

10. A method according to claim 8 wherein the substructure is a 3,4,5-trihydroxybenzoyl unit or substituted derivatives thereof.

11. A method according to claim 10 wherein the antioxidant is chosen from gallic acid and its amides and esters and salts, tannic acid and its esters and salts, tannin, epigallocatechin gallate and theaflavin digallate.

12. A method according to claim 4 wherein the antioxidant is part of a cleaning composition also comprising a detergent surfactant.

13. A method according to claim 3 wherein the antioxidant is applied with a wipe impregnated with the antioxidant or the composition comprising the antioxidant.

14. Use of an antioxidant for facilitating removal of soil from a surface to which the antioxidant has been applied.

15. Use according to claim 14 wherein the soil is a fatty soil.

16. Use according to claim 14 wherein the antioxidant is applied to the surface neat.

17. Use according to claim 14 wherein the antioxidant is applied to the surface in liquid diluted form.

18. Use according to claim 14 wherein the antioxidant is a natural antioxidant.

19. Use according to claim 14 wherein the antioxidant contains one of the following substructures:
HO>=<OH
HO>=−=<OH
or a derivative thereof in which of one or both OH (preferably only one) the H has been replaced by an organic group.

20. Use according to claim 19 wherein the antioxidant comprises ascorbic acid and salts thereof and ascorbyl esters.

21. Use according claim 19 wherein the substructure is a 1,2- or 1,4 dihydroxybenzene unit or derivative thereof.

22. Use according to claim 21 wherein the antioxidant is chosen from caffeic, ferulic rosmarinic and vanillic acid and their amides and esters and salts, sesamol and its derivatives, tocopherols and tocotrienols.

23. Use according to claim 21 wherein the substructure is a 3,4,5-trihydroxybenzoyl unit or substituted derivatives thereof.

24. Use according to claim 23 wherein the antioxidant is chosen from gallic acid and its amides and esters and salts, tannic acid and its esters and salts, tannin, epigallocatechin gallate and theaflavin digallate.

25. Use according to claim 17 wherein the antioxidant is part of a hard surface cleaning composition also comprising a detergent surfactant.

26. Use according to claim 16 wherein the antioxidant is applied with a wipe impregnated with the antioxidant or the composition comprising the antioxidant.

27. Use of an antioxidant in the manufacture of a product containing that antioxidant, the product being for treatment of a surface to be subsequently cleaned to enable easier removal of soil from the hard surface during said subsequent cleaning.

28. Use of an antioxidant according to claim 27 wherein the product is a liquid.

29. Use of an antioxidant according to claim 27 wherein the product is a wipe.

30. Use of an antioxidant according to claim 27 wherein the antioxidant is a natural antioxidant.

31. Use of an antioxidant according to claim 27 wherein the antioxidant contains one of the following substructures:
HO>=<OH
HO>=−=<OH
or a derivative thereof in which of one or both OH (preferably only one) the H has been replaced by an organic group.

32. Use of an antioxidant according to claim 31 wherein the antioxidant is chosen from: ascorbic-acid and salts thereof and ascorbyl derivatives, caffeic, ferulic rosmarinic and vanillic acid and their amides and esters and salts, sesamol and its derivatives, tocopherols and tocotrienols, gallic acid and its amides and esters and salts, tarnic acid and its esters and salts, tannin, epigallocatechin gallate and theaflavin digallate.

33. A liquid composition having a pH less than 12 and comprising a detergent surfactant in an amount of 0.05-45% by weight and an antioxidant in an amount of 0.01-10% by weight and having a viscosity of at least 100 mPaS at a shear rate of 21s⁻¹.

34. A composition according to claim 33, comprising a thickener.

35. A composition according to claim 34 wherein the thickener is xanthan gum.

36. A composition according to claim 33, wherein the viscosity is at least partly due to one or more surfactants and optionally, electrolyte, in said composition.

37. A composition according to any of claim 33 wherein the antioxidant is a natural antioxidant.

38. A composition according to claim 33 wherein the antioxidant is as defined in any of claims 6-11.

39. A composition according to claim 38 wherein the antioxidant is chosen from ascorbic acid and a salt thereof and ascorbyl esters, caffeic, ferulic rosma:rinic, and vanillic acid and their amides and esters and salts, sesamol and its derivatives, tocopherols and tocotrienols, gallic acid and its amides and esters and salts, tannic acid and its esters and salts, tannin, epigallocatechin gallate and theaflavin digallate.

40. A composition according to claim 33 which comprises at least two antioxidants.

41. A composition according to claim 33 which additionally comprises 0.05-5% of a metal ion sequestrant.

42. A composition according to claim 41 wherein the sequestrant is citric acid or phosphate.

43. A wipe comprising an antioxidant or a composition comprising an antioxidant.

44. A wipe according to claim 43 wherein the composition is as defined in any of claims 33-42.

45. A dispenser for a liquid, the dispenser comprising a reservoir containing a liquid composition comprising an antioxidant in an organic or aqueous solvent and having a pH below 12, and spray means for dispensing said liquid in the form of a spray.

46. A dispenser according to claim 45, wherein the spray means is a trigger spray.

47. A dispenser according to claim 45 wherein the liquid contains a metal ion sequestrant.

48. A dispenser according to claim 45 wherein the composition comprises less than 0.1% by weight of detergent surfactant.

49. A composition for use in machine dish wash operations comprising an antioxidant.

50. A composition according to claim 49 which is a rinse aid.

51. A rinse aid according to claim 50 which comprises citric acid and/or a wetting surfactant and at least 0.05% of antioxidant.
